(19) United States
(12) Patent Application Publication
(10) Pub. No.: US 2022/0071320 A1
(43) Pub. Date: Mar. 10, 2022

(54) Microfluidic PDMS face mask

(71) Applicant: Tamkang University, NEW TAIPEI CITY (TW)

(72) Inventors: LUNG-JIEH YANG, NEW TAIPEI CITY (TW); Vivek Jabaraj, ANDAMAN & NICOBAR ISLANDS (IN); Reshmi Waikhom, Imphal (IN)

(73) Assignee: Tamkang University, NEW TAIPEI CITY (TW)

(21) Appl. No.: 17/208,334

(22) Filed: Mar. 22, 2021

(30) Foreign Application Priority Data
Sep. 9, 2020 (TW) 109130952

(51) Int. Cl. A41D 13/11

(52) U.S. Cl. CPC A41D 13/1107

(57) ABSTRACT

Provided is a microfluidic PDMS face mask, including a face mask body having a plurality of bores mounted on a surface thereof, a microfluidic block array including a plurality of microfluidic blocks being arranged in arrays and received in the bores, each of the microfluidic block includes a microfluidic module for allowing a fluid to flow therethrough, thereby capturing microparticles, and a strap having one end attached to a left side of the face mask body and the other end attached to a right side of the face mask body for adhering the face mask body to the face of a user.

### FIELD OF THE DISCLOSURE

The invention is related to a face mask, and more particularly to a microfluidic PDMS face mask having a microfluidic block array made of PDMS for filtering out aerosols with virus.

### BACKGROUND OF THE INVENTION

Medical face masks have been prevalently used in daily life. Face mask is especially suitable in defending the body from allergic substances, air pollutants and odorous stench and protecting the body from cold. Nonetheless, for the purpose of filtering out particulate pollutants, the commercially available face mask is made up of unwoven fabric with excessively high density, which would increase the breathing resistance of the wearer of the face mask, and thus cause difficulty in breathing, hypoxia, chest tightness, and dizziness.

Since the outbreak of COVID-19 pandemic, respiratory diseases, such as influenza, have been seriously spread among people that would develop symptoms including cough, fever, and difficulty in breathing. The respiratory disease is spread by way of droplet infection. Thus, people are forced to keep a social distance with each other. The so-called aerosol indicates tiny substance or liquid floating in the air (or floating particles). The use of face mask can efficiently stop the spread of aerosol with pathogenic virus among people. Hence, the use of face mask is one of the most effective way to contain respiratory contagion. According to the medical references, aerosols with pathogenic virus are particles with a diameter of pm. Therefore, an authentic face mask must possess the capability of filtering out aerosols with a diameter of 5 μm. However, the commercially available face mask has the following deficiencies:

1. The filter of the commercially available face mask is made of multi-layer unwoven fabric with high density. Thus, the preciseness and impermeability of the filter cannot be ensured as the filtering layers are stacked together. This would tarnish the filtering effect of face mask.

2. In order to ensure the airtightness and antileak ability of the face mask, a foamed washer is additionally mounted on the periphery of the face mask, and a flex strap is used to affix the face mask to the face and head of the user. However, such arrangement is prone to cause uncomfortableness after long-term usage. Thus, most of the users are reluctant to wear the face mask.

In order to remove the foregoing deficiencies, a new microfluidic channel design has been proposed as shown in FIG. 1. In FIG. 1, a bionic dragonfly microstructure combined with microfluidic channel is presented, which includes a two-stage microfluidic channel with a dragonfly wing structure for generating local vortex. The two-stage microfluidic channel with a dragonfly wing structure in this reference is composed of an inlet a1, a microfluidic channel a2, a partition plate a3, a siltation area a4, and an outlet a5. Local vortex is generated in corrugated grooves on the tube walls of the microfluidic channel to facilitate the capture of aerosols. Moreover, as the partition plate a3 divides the fluid channel into a channel of a greater flow resistance and another channel of a smaller flow resistance, the flow speed of aerosol is slowed down, which would in turn increase the possibility of allowing the tube wall to capture the aerosols. Because the length of the microfluidic channel having a tilted inlet and a dragonfly wing structure is not capable of capturing all of the microparticles, another dragonfly wing structure must be added to the microfluidic channel to create a microfluidic channel with a double dragonfly wing structure. However, this microfluidic channel design is deficient in that a large quantity of microparticles would be accreted in the siltation area a4 located in the downstream region of the microfluidic channel to block the microfluidic channel, which would hinder the capture of microparticles.

In order to remove the deficiency of the microfluidic channel of FIG. 1, another microfluidic channel design is proposed, as shown in FIG. 2. In FIG. 2, a second exit is disposed at the siltation area located in the downstream region of the microfluidic channel. When experimenting, a mixed gas having 5-μm microparticles and 20-μm microparticles is transmitted through the inlet. In FIG. 2, reference numeral b1 denotes an inlet, reference numeral b2 denotes a microfluidic channel, reference numeral b3 denotes a partition plate, reference numeral b4 denotes an opening, reference numeral b5 denotes a first exit, and reference numeral b6 denotes a second exit. The design of FIG. 2 reserves an accommodating space at the second exit b6 for receiving captured microparticles and ease the siltation effect occurred at the opening b4. The experiment result shows that 80-82% of the 20-μm microparticles is discharged from the channel, while only 38-42% of the 5-μm microparticles (which is about the size of aerosol) is captured in the microfluidic. Thus, it is evident that the microfluidic channel design of FIG. 2 can capture both large microparticles and small microparticles. Nonetheless, the ability to capture 5-μm microparticles (aerosols) for the microfluidic channel design of FIG. 2 is not good (only 38-42% of the 5-μm microparticles is captured). Therefore, there is a need to provide a microfluidic channel design capable of substantially capturing small microparticles.

### SUMMARY

To this end, a microfluidic PDMS (Polydimethylsiloxane) face mask is provided, which includes a face mask body, a microfluidic block array, and a strap.

The face mask body can be flexibly adapted according to facial characteristics on different areas of the human face. The face mask body includes a plurality of bores on a surface thereof for receiving a microfluidic block array. The microfluidic block array includes a plurality of microfluidic blocks being arranged in arrays and received in the bores for allowing a fluid, such as air, to flow therethrough. Both ends of the strap are attached to a left side and a right side of the face mask body, respectively, for adhering the face mask body to the face of a user.

According to the invention, each of the microfluidic block includes a microfluidic module. The microfluidic module is a microstructure and includes an inlet, a microfluidic channel, a plurality of cilia, two first exits, and a second exit. The microfluidic module is provided with two passageways with a tilt angle of 50-60 degrees being respectively arranged between the inlet and one of the first exits for increasing fluidic vortex to slow down the flow speed of the fluid flowing through the microfluidic channel and prolonging the period of the fluid flowing in the microfluidic channel, thereby increasing the possibility of capturing the microparticles.

According to the invention, the microfluidic PDMS face mask is manufactured with silicone in an integral manner.

According to the invention, the microfluidic module can capture and filter out 70% of the 5-μm microparticles.

### BRIEF DESCRIPTION OF THE DRAWINGS

Next, the invention will be described in detail with reference to the accompanying drawings.

FIG. 1 is a schematic diagram showing a bionic dragonfly microfluidic structure according to the prior art;

FIG. 2 is a schematic diagram showing a bionic dragonfly microfluidic structure having two exits according to the prior art;

FIG. 3 is schematic diagram showing the microfluidic PDMS face mask according to a preferred embodiment of the invention;

FIG. 4 is an exploded view showing the structure of the microfluidic PDMS face mask according to a preferred embodiment of the invention;

FIG. 5 is a top view showing the structure of the microfluidic PDMS face mask according to a preferred embodiment of the invention;

FIG. 6 is a bottom view showing the structure of the microfluidic PDMS face mask according to a preferred embodiment of the invention;

FIG. 7 is a cross-sectional view showing the profile of the microfluidic module according to a preferred embodiment of the invention; and

FIG. 8 is a schematic diagram illustrating the manufacturing of the microfluidic PDMS face mask according to a preferred embodiment of the invention.

### DETAILED DESCRIPTION OF PREFERRED EMBODIMENTS

Next, in order to facilitate the understanding of the invention, a preferred embodiment is given below with reference to the accompanying drawings to illustrate the content and effect of the invention. Nonetheless, it is to be noted that the invention can be accomplished in a variety of manners which are to be covered and defined by the appended claims and their equivalents. Also, it is to be noted same elements are designated with same reference numerals throughout the specification.

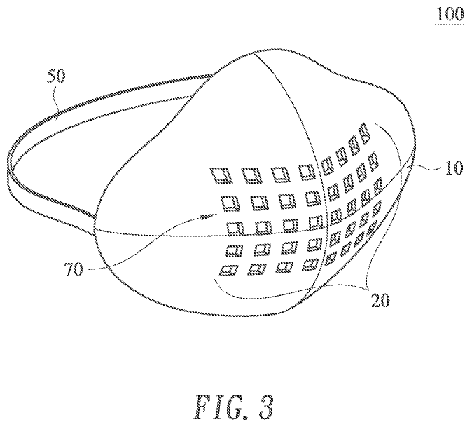

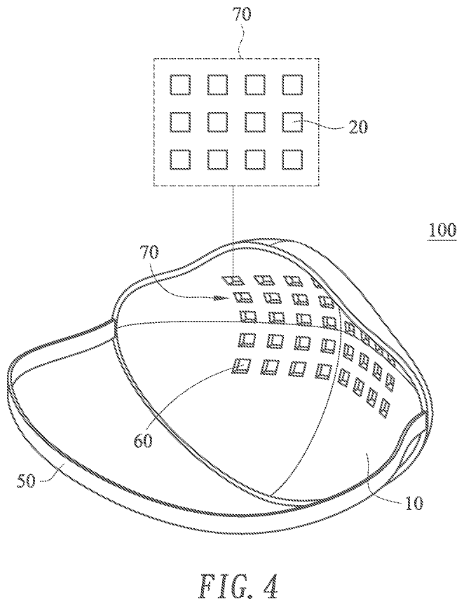

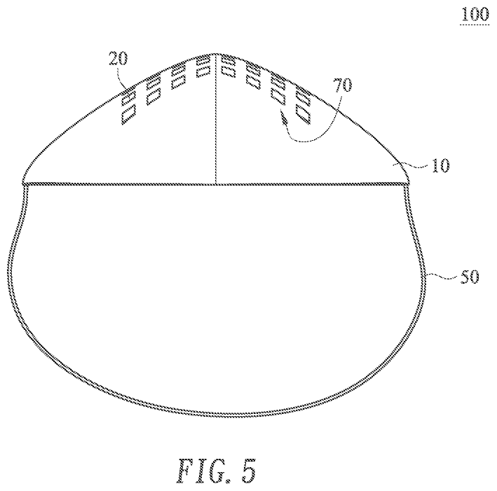

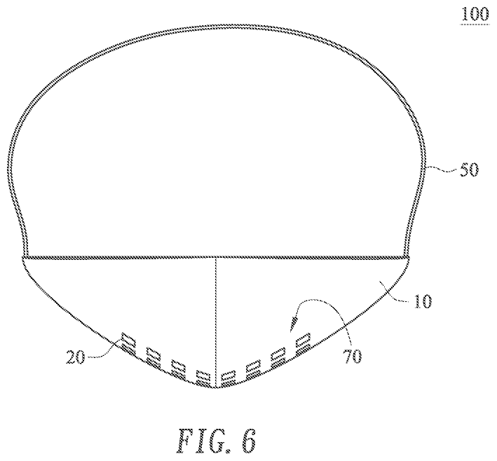

Firstly, as shown in FIGS. 3-7, the invention provides a PDMS (Polydimethylsiloxane)face mask 100, which includes a face mask body 10, a microfluidic block array 70, and a strap 50. The face mask body 10 can be flexibly adapted according to facial characteristics on different areas of the human face. The surface of the face mask body 10 is provided with a plurality of bores 60 that are arranged in arrays. The microfluidic block array 70 is consisted of a plurality of microfluidic blocks 20 that are arrayed on the surface of the face mask body 10. Each microfluidic block 20 is consisted of a microfluidic module 30 for allowing a fluid to pass therethrough. Both ends of the strap are respectively attached to a left side and a right side of the face mask body 10. When in use, the face mask body 10 is adhered to the face of a user for filtering out microparticles.

The microfluidic modules 30 of the microfluidic blocks 20 are secured within the bores 60 to form a microfluidic block array 70.

The microfluidic module 30 is a hollow and symmetric dual-channel curved structure having an inlet 31, two symmetric microfluidic channels 32, a plurality of cilia 33, two first exits 34, and a second exit 35 located at the confluence of an upper flow channel and a lower flow channel. Two passageways with a tilt angle of 50-60 degrees are respectively arranged between the inlet 31 and one of the first exits 34 for increasing the fluidic vortex to slow down the flow speed of the fluid flowing through the microfluidic channel 32 and prolonging the period of the fluid flowing in the microfluidic channel 32. In this way, the possibility of capturing the microparticles is elevated.

The microfluidic face mask of the invention is manufactured by silicone in an integral manner, thereby saving the laboring and cost of the manufacturing process.

Preferably, the filtration ratio of the microfluidic module 30 for 5-μm microparticles is 70%.

The microfluidic module 30 includes a plurality of cilia 33, which are perpendicular to and integrated with the inner wall of the microfluidic channel 32 to capture and filter out microparticles.

Furthermore, small compartments are created between each cilium 33 for generating local vortex to slow down the flow speed and facilitate the capture of microparticles. The cilia 33 act as a flexible and flat artificial trachea capable of filtering out aerosol particles before they contact the trachea cilia of the human body, thereby protecting the human body from being infected with virus. The filtration ratio of the microfluidic module 30 for 5-μm aerosol particles is 70%.

The strap 50 may be made of a material with comfortability, such as silicone, cotton cloth, and unwoven fabric.

The length and width of the microfluidic PDMS face mask of the invention are analogous to the commercially available face mask, and the thickness of the microfluidic PDMS face mask of the invention is 3 mm. The 3-mm thickness of the microfluidic PDMS face mask of the invention may be identical to the distance between the inlet 31 and the first exit 34.

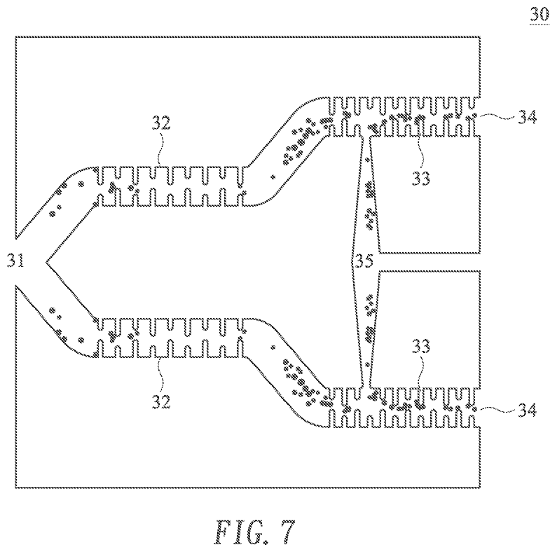

Please refer to FIG. 7. FIG. 7 is the cross-sectional view of the microfluidic channel of the microfluidic PDMS face mask of the invention. In FIG. 7, reference numeral 30 denotes the microfluidic module 30, reference numeral 31 denotes the inlet, reference numeral 32 denotes the microfluidic channel, reference numeral 33 denotes cilia, reference numeral 34 denotes first exit, and reference numeral 35 denotes second exit. In order to prove the filtering effect for microparticles of the invention, we performed a particle flow simulation experiment on COMSOL Multiphysics software, and the experimental result is shown in Table 1 below. Table 1 shows the percentage of 5-μm microparticles and the percentage of 20-μm microparticles in different areas in the microfluidic channel. It can be readily known from Table 1 that 30% of the 5-μm microparticles remains at the first exit 34 (which is the main exit), which means 70% of the 5-μm microparticles is filtered out, and 98% of the 20-μm microparticles remains at the first exit 34, which means almost all of the 20-μm microparticles flows through the microfluidic channel without being captured or filtered out. According to the Table 1, the cilia structure of the microfluidic channel shown in FIG. 7 of the invention has a better capturing and filtering effect for 5-μm microparticles than the conventional dragonfly wing structure of the microfluidic channel shown in FIG. 2.

TABLE 1

| Microfluidic | | | | at 34 | |
|---|---|---|---|---|---|
| channel | Particle Size | at 32 | at 33 | (exit) | at 35 |
| 3-mm long | 5 μm | 4% | 8% | 30% | 58% |
| and 80-μm | 20 μm | 0% | 0% | 98% | 2% |
| thick | | | | | |

In conclusion, the features and functions of the invention are enumerated as follows:

1. The COMSOL Multiphysics simulation experiment result shows that 98% of the large particles (20-μm particles) are directly discharged from the microfluidic channel, while 70% of the small particles (5-μm particles) are captured by the cilia of the microfluidic channel.

2. The low flow resistance of the microfluidic channel of invention allows the user to breathe smoothly, such that the user would be glad to persistently wear the PDMS face mask of the invention.

3. The face mask of the invention uses silicone (PDMS is an organosilicon). Hence, the face mask of the invention possesses great biocompatibility and water-tightness.

4. Silicon is known to have high flexibility and high adhereability. Thus, the user can wear the face mask of the invention stably.

5. The PDMS face mask of the invention is transparent and beautiful. Thus, westerners would be glad to adopt the PDMS face mask of the invention.

6. The silicone, preferably PDMS, has a temperature tolerance of 200° C. More advantageously, the PDMS face mask of the invention can be disinfected by simply heating the PDMS face mask and can be used repeatedly.

7. After the COVID-19 pandemic is over, the technique of the invention can be applied to deal with the PM 2.5 pollutions.

8. The PDMS face mask of the invention can be molded by injection molding of liquid silicone rubber.

9. The bionic cilia microstructure on the surface of the mask acts as a flexible and flat artificial trachea for helping the trachea cilia of the human body to filter out aerosols with virus beforehand.

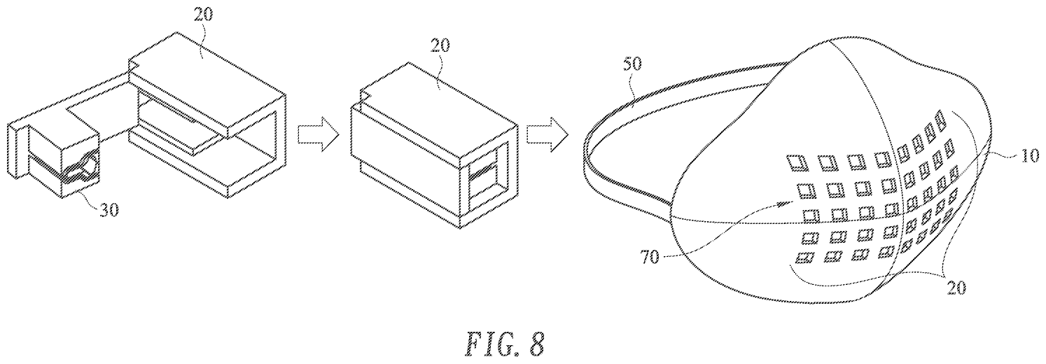

Lastly, please refer to FIG. 8. FIG. 8 shows the contour of the microfluidic block 20 of the microfluidic PDMS face mask and the microfluidic block array 70 formed thereby. In FIG. 8, during the manufacturing process, the closed geometric contour of the microfluidic block 20 cannot be attained one-stop by the plastic injection molding process. Instead, the internal structure of the microfluidic channel must be pushed aside and then the plastic injection molding process is applied to mold the microfluidic block 20, as shown in the leftmost image of FIG. 8.

After the open-up microfluidic block 20 is attained, a “close-down” process must be applied to seal off the microfluidic block. In a preferred embodiment of the invention, as the PDMS face mask employs PDMS as the silicone material, we can apply the PDMS plasma bonding technique which is a well-known skill in the microelectromechanical Systems (MEMS) process to bond and seal off the microfluidic block, as shown in the central image of FIG. 8.

Finally, each microfluidic block is embedded into a bore of the face mask, thereby forming the microfluidic block array 70, as shown in the rightmost image of FIG. 8.

It is to be noted that the microfluidic PDMS face mask of the invention adopts silicone as the material of the face mask for its optical transparency. Moreover, silicone is characterized as an inert, non-toxic, thermally resistive, non-flammable material, and is a widely-used organic polymer. Thus far silicone has been employed in microfluidic system in MEMS, caulk, contact lens, and biocompatible stuffing.

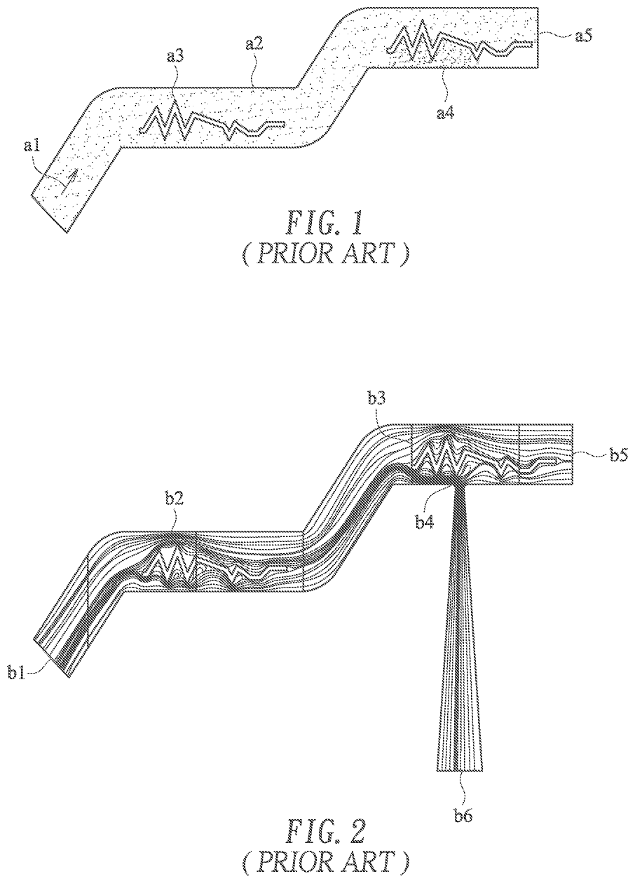

In sum, compared to the prior art of FIG. 1 and the prior art of FIG. 2, the inventive microfluidic PDMS face mask has the following advantages:

1. The inventive microfluidic PDMS face mask can filter out 70% or more of the aerosols in the air, so as to safeguard the health of human body.

2. The low flow resistance of the microfluidic channel of invention allows the user to breathe smoothly, such that the user would be glad to persistently wear the PDMS face mask of the invention.

3. The face mask of the invention uses silicone. Hence, the face mask of the invention possesses great biocompatibility and water-tightness.

4. Silicon is known to have high flexibility and high adhereability. Thus, the user can wear the face mask of the invention stably.

5. The PDMS face mask of the invention is transparent and beautiful. Thus, westerners would be glad to adopt the PDMS face mask of the invention.

6. The PDMS face mask of the invention can be molded by injection molding of liquid silicone rubber, thereby saving manufacturing cost.

8. The PDMS face mask of the invention can be disinfected by simply heating the PDMS face mask and can be used repeatedly.

9. After the COVID-19 pandemic is over, the technique of the invention can be applied to deal with the PM 2.5 pollutions.

Hence, the invention can achieve the effect that is unforeseeable by the prior art.

The above descriptions only disclose a preferred embodiment of the invention. However, it is to be understood that the invention should not be limited to the accurate form or the preferred embodiments disclosed herein. The preferred embodiments stated above cannot be taken to limit the scope of the invention. The invention should encompass various modifications and alterations made based on the foregoing embodiments. An artisan having ordinary skill in the art can understand the way to embody the foregoing embodiment, and the equivalent modifications which are made based on the claims are still within the scope of the invention.

What is claimed is:

1. A microfluidic PDMS face mask, comprising:
a face mask body having a plurality of bores mounted on a surface thereof;
a microfluidic block array including a plurality of microfluidic blocks being arranged in arrays and received in the bores, each of the microfluidic block includes a microfluidic module for allowing a fluid to flow therethrough, thereby capturing microparticles; and
a strap having one end attached to a left side of the face mask body and the other end attached to a right side of the face mask body for adhering the face mask body to a face of a user.

2. The microfluidic PDMS face mask according to claim 1, wherein the microfluidic modules of the microfluidic blocks are constructed in a hollow and symmetric dual-channel curved structure.

3. The microfluidic PDMS face mask according to claim 1, wherein the microfluidic module of the microfluidic block includes an inlet, a microfluidic channel, a plurality of cilia, two first exits, and a second exit, and wherein the microfluidic module is provided with two passageways with a tilt angle of 50-60 degrees being respectively arranged between the inlet and one of the first exits for increasing fluidic vortex to slow down a flow speed of the fluid flowing through the microfluidic channel and prolonging a period of the fluid flowing in the microfluidic channel, thereby increasing the possibility of capturing the microparticles.

4. The microfluidic PDMS face mask according to claim 1, wherein the microfluidic PDMS face mask is manufactured with silicone in an integral manner.

5. The microfluidic PDMS face mask according to claim 1, wherein the microfluidic module includes a plurality of cilia being perpendicular to and integrated with an inner wall for capturing the microparticles.

6. The microfluidic PDMS face mask according to claim 5, wherein the microfluidic module further includes a plurality of compartments between each cilium of the cilia for generating local vortex to slow down a flow speed of the fluid.

7. The microfluidic PDMS face mask according to claim 1, wherein the strap is made of silicone, cotton cloth, or unwoven fabric.
